(19) United States
(12) Patent Application Publication
(10) Pub. No.: US 2026/0346692 A1
(43) Pub. Date: Nov. 5, 2026

(54) UTILITY VEHICLE

(71) Applicant: Daimler Truck AG, Leinfelden-Echterdingen (DE)

(72) Inventor: Julia Christina WOLF, Leinfelden-Echterdingen (DE)

(21) Appl. No.: 19/124,768

(22) PCT Filed: Oct. 6, 2023
(86) PCT No.: PCT/EP2023/077764

§ 371 Date: Apr. 25, 2025

(30) Foreign Application Priority Data
Oct. 28, 2022 (DE) 10 2022 128 747.5

(51) Int. Cl. B60K 1/04

(52) U.S. Cl. CPC B60K 1/04; B60K 2001/0438; B60Y 2200/145

(57) ABSTRACT

This invention concerns a utility vehicle comprising a battery-powered electric drive and a mounting arrangement (11, 23, 47) of battery modules (9) on the chassis (15). In a utility vehicle, which enables a stable connection of the batteries onto the chassis in a simple manner, the mounting arrangement has at least one truss support structure (11, 23, 47) with a battery support surface (33, 51), to which at least one battery housing (7) is attached in a force-fit manner, and includes at least one mounting plate (61) that is attached to a frame of the chassis (15) and has a vertical strut (63) to which the truss support structure (23, 47) is attached.

The invention relates to a utility vehicle comprising a battery-powered electric drive and a mounting arrangement for the batteries on the chassis.

DE 10 2020 004 026 A1 discloses a portable battery holder for utility vehicles, which has compartments for holding the battery modules, which are built from the longitudinal members of the utility vehicle and the cross-members. The compartments are designed as truss modules, which are connected to the two longitudinal members of the utility vehicle on one upper side, running centrally and transversely with respect to the vehicle. The truss modules have a retaining rail for the battery module and lateral compression or tension struts connected to the retaining rail and the cross-member.

DE 10 2020 128 582 A1 discloses a vehicle with a battery holder. The battery holder has a box-shaped design to accommodate the battery and is arranged between the two longitudinal members of a carrier frame of the vehicle.

The purpose of the invention is to provide a utility vehicle which enables a simple and stable connection of the batteries with the chassis.

The invention results from the features of the independent claims. Advantageous further developments and embodiments are the subject of the dependent claims. Further features, possible applications and advantages of the invention are shown in the subsequent description, as well as in the explanation of embodiments of the invention, which are shown in the figures.

The problem is solved with the object of patent claim 1.

The utility vehicle explained at the beginning comprises a battery-powered electric drive and a mounting arrangement for the batteries on the chassis, wherein this mounting arrangement has at least one truss support structure with a battery support surface, to which at least one battery housing is attached in a force-fit manner, and includes at least one mounting plate that is attached to a frame of the chassis and has a vertical strut to which the truss support structure is attached. The truss structure enables the exceptional stable holding of the batteries so that they can be used reliably over long ranges while the electrically powered utility vehicle is in motion.

The mounting plate is advantageously integrated into a bearing block of a chassis component, such as the stabilizer, the plate cross-member and/or the Panhard rod. This eliminates the need for additional mounting elements, which reduces the cost of manufacturing the mounting arrangement. The bearing block retains its original function.

In one embodiment, the mounting plate is formed by an extension of the bearing block in the longitudinal direction of the chassis frame. By enlarging the area of attachment to the ladder frame of the chassis, forces are applied over a large area of the chassis.

In one variant, the truss support structure is connected to the vertical strut of the mounting plate via a Z-shaped support element, which provides the truss support structure with a support and is attached to it, in particular bolted onto it. The vertical strut can be used to support large forces in the longitudinal direction of the vehicle, for example during a braking maneuver. At the same time, the mounting arrangement can be attached to the chassis to save space.

In one embodiment, at least two battery housings of the battery modules are coupled together in a self-supporting manner. This further improves the stability of the battery modules attached to the vehicle and prevents them from slipping against each other.

It is advantageous if the battery housings have positive-locking elements and mating positive-locking elements on their front sides facing each other, by means of which the battery housings are positively connected to each other. The use of positive-locking and counter-locking elements reduces the assembly effort of the batteries in the mounting arrangement, since the battery modules only need to be pushed into one another.

In a further embodiment, the positive-locking or mating positive-locking elements in the form of a groove have an undercut which prevents the battery housings from slipping out in the longitudinal direction.

In a further variant, the battery housings are connected to each other on their underside by means of a screwed-on retaining strip, which prevents the housings from slipping out of the positive-locking connection in the transverse direction.

In a further embodiment, the box-like truss support structure is formed by two end structural elements with diagonal straps, a base structure with diagonal straps resting on support flanges of the end structural elements and bolted there, longitudinal profiles connect the end structural elements with each other in the respective corner areas, and diagonal struts connect the longitudinal profiles with each other. The diagonal straps prevent the lower part of the mounting arrangement from buckling and improve the transfer of transverse forces into the battery housing. The struts increase the rigidity and stability of the design of the mounting arrangement. At the same time, many identical parts are used to attach the battery housing.

In a further variant, transverse elastic buffer walls separating the battery housings are arranged within the box-like truss support structure. This allows the mounting arrangement to be divided into sections, which ensures that the battery housings are protected from mutual damage.

In an alternative, the truss support structure is formed by two structural elements on the end faces and arranged parallel between them with diagonal straps and lower battery support surfaces and support surfaces formed in the upper corner areas that extend lengthways to the structural elements on the end faces. Even in this case, the fastening structure is divided into individual sections, with each section having a high degree of rigidity.

In a further embodiment, the structural elements are firmly connected to each other by longitudinal strips attached in the base area. Such longitudinal strips can at least be used partially as a support surface for the battery housing.

In a further embodiment, the structural elements have diagonal struts at their ends which connect the corners with each other. These corner connections enable the forces to be transferred over a wide area in the longitudinal direction.

In a further embodiment, the mounting plate together with the vertical strut is formed by a cast steel part or a forged part made of steel or an aluminum alloy. This allows the material to be specifically selected depending on the application.

Further advantages, features and details are specified in the following description, in which-if necessary with reference to the drawing-at least one embodiment is described in detail. Described and/or illustrated features may form the subject matter of the invention on their own or in any meaningful combination, possibly also independently of the claims, and may in particular also be the subject matter of one or more separate application(s). Identical, similar and/or functionally identical parts are provided with the same reference signs.

In the drawings:

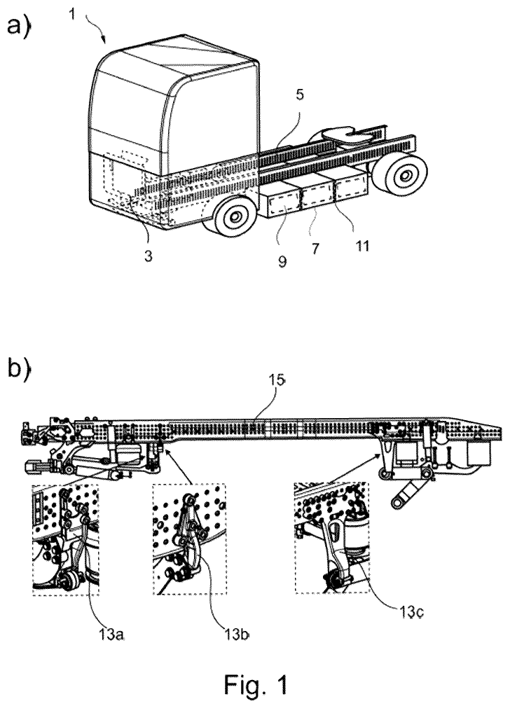

FIG. 1 shows a schematic representation of a utility vehicle with battery modules,

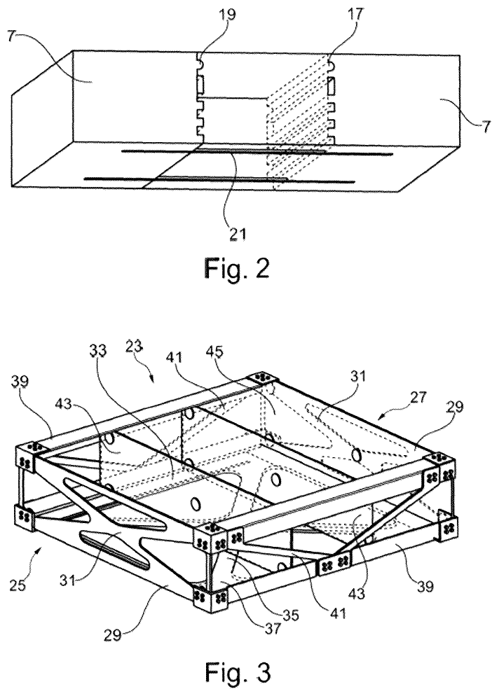

FIG. 2 shows a first embodiment of the mounting arrangement,

FIG. 3 shows a further embodiment of the mounting arrangement,

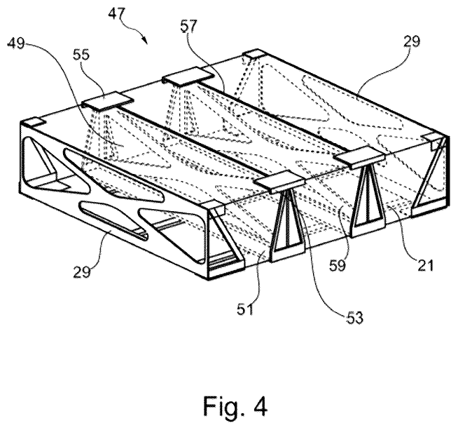

FIG. 4 shows a further embodiment of the mounting arrangement,

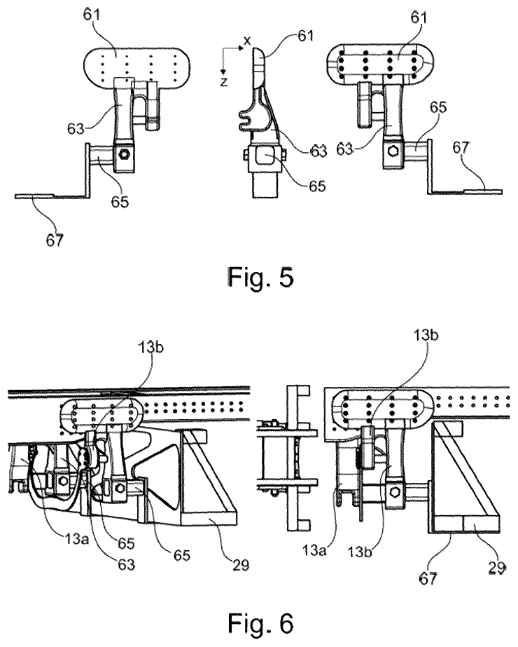

FIG. 5 shows a schematic representation of the mounting plate,

FIG. 6 shows an embodiment for fastening the mounting arrangement to the mounting plate,

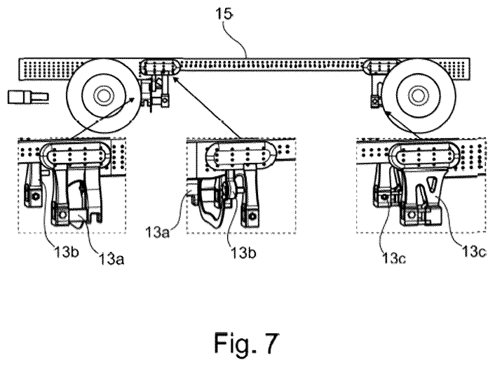

FIG. 7 shows an embodiment of various mounting plates,

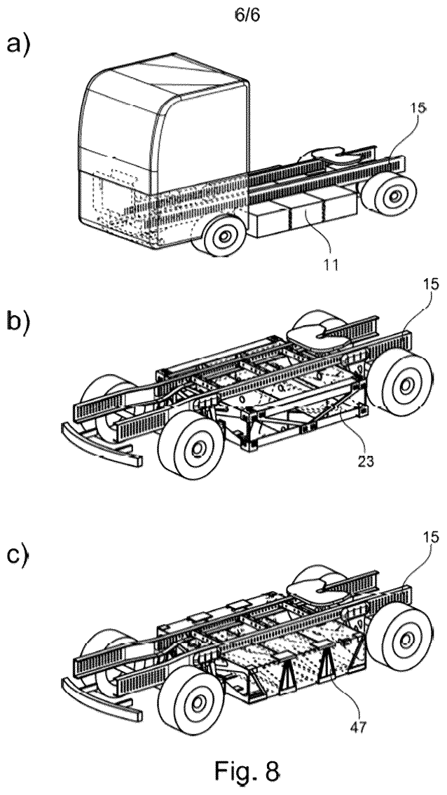

FIG. 8 shows the positioning of different mounting arrangements on the utility vehicle.

FIG. 1 shows an embodiment of a utility vehicle with battery modules. The electrically powered utility vehicle 1 consists of a tractor unit 3 and a semi-trailer 5, whereby battery housings 7 are attached to the tractor unit 3, in which battery modules 9 are mounted (FIG. 1a). The battery housings 7 are fastened via a mounting arrangement 11. The mounting arrangement 11, which can support between two and four battery modules, is provided via the bearing blocks 13 on the chassis 15 of the utility vehicle 1, which are shown in FIG. 1b. These bearing blocks are used to attach the Panhard rod 13a, the plate cross-member 13b and the stabilizer 13c. The Panhard rod 13a is required for safe axle guidance, while the stabilizer 13c enables lateral forces to be supported, for example when cornering.

The mounting arrangement 11, which holds the battery housing 7, can take various forms. FIG. 2 shows a first example of the mounting arrangement 11, in which the battery housings 9 are self-supporting. For this purpose, the battery housings 7 have grooves 17 or folds 19 on the sides facing each other, so that one battery housing 7 and the adjacent battery housing 7 can be pushed laterally into each other. The battery housings 7 are thus positively connected to each other. The grooves 17 have an advantageous undercut against which the battery row is secured against slipping out in the longitudinal direction. In addition, grooves 17 with a rectangular cross-section can also be provided. This serves to simplify production, since the undercut grooves 17 must have a significantly lower production tolerance. In addition, the grooves serve to secure the central battery housing 7 in a vertical direction and to stiffen the battery system due to the shape of the components. The battery housings 7 are connected with each other on their underside using a screwed-on retaining strip 21, which prevents the battery housings 7 from slipping out of the positive-locking connection in the transverse direction.

FIG. 3 shows a further embodiment of the mounting arrangement. The fastening structure is designed as a box-shaped truss support structure 23, which is formed at each of its front sides 25, 27 by a structural element 29 with two diagonal straps 31. A base structure 33, which also has two diagonal straps 35, rests on the support flanges 37 of the structural elements 29 and is bolted onto them.

The end-face structural elements 29 are each bolted together in the corresponding corner areas 39 via a longitudinal profile 39, whereby the superimposed longitudinal profiles 39 are connected to each other via diagonal struts 41. The box-shaped truss support structure 23 is divided by elastic buffer walls 43 into individual sections 45, each of which accommodates a battery housing 7. For this purpose, the elastic buffer walls 43 extend in the transverse direction of the box-shaped truss support structure 23.

A further embodiment of the mounting arrangement is shown in FIG. 4, in which the box-shaped truss support structure 47 is extended. Between the two external structural elements 29, further intermediate structural elements 49 with diagonal straps 31 run parallel to them on the inside. These intermediate structural elements 49 have support surfaces 51 for the battery housings 7 in their lower area. In the upper corner areas 53 of the intermediate structural elements 49, support surfaces 55 extend transversely thereto for fixing the battery housings in the longitudinal, transverse and vertical directions. All structural elements 29, 49 are firmly connected to one another via longitudinal strips 57 attached in the base area. In addition, the intermediate structural elements 49 also have diagonal straps 59 at their ends, which connect the corners to each other.

In this embodiment shown in FIG. 4, the assembly is carried out such that the one end-face structural element 29 is pushed onto the first battery housing 7 and screwed in place, after which the first intermediate structural element 49 is pushed into the other side of the first battery housing 7 and screwed in place. The second battery housing 7 is then pushed into the first intermediate structural element 49 from the other side and screwed in place. This process is repeated using further intermediate structural elements 49 until the second end-face structural element 29 forms the end of the entire truss support structure 47.

As already explained, the mounting arrangement 11, 27, 47 is attached to the bearing blocks 13 of the chassis 15 of the tractor unit 3. FIG. 5 shows a schematic representation of a mounting plate 61 for receiving the mounting arrangement 11, 27, 47, which is formed by an extension of the bearing block 13 in the longitudinal direction of the chassis frame. A vertical web 63 protrudes from the mounting plate 61 and is formed in one piece with the mounting plate 61. A Z-shaped support element 65, which is designed in the manner of a trowel, engages with the vertical web 63. The support element 65 has a support 67 on which the truss support structure 27, 47 rests and onto which it is bolted. For the sake of clarity, only one end structural element 29 of the truss support structure is shown in FIG. 6. The respective mounting plate 61 together with the vertical strut 63 is formed as a cast steel part or a forged part made of steel or an aluminum alloy.

FIG. 7 shows the bearing blocks for attaching the Panhard rod 13a, plate cross-members 13b and the stabilizers 13c, which are extended by the retaining element 61 and the vertical strut 63.

FIG. 8 shows the positioning of the individual mounting arrangements 11, 23, 47 in the utility vehicle 1 in individual views 8a to 8d.

### List of Reference Signs

1 Utility vehicle
3 Tractor unit
5 Semi-trailer
7 Battery housing
9 Battery module
11 Mounting arrangement 13 Bearing block
15 Chassis
17 Groove
19 Fold
21 Retaining strip
23 Box-shared truss support structure
25 Front side
27 Front side
29 Structural element
31 Diagonal straps
33 Base structure
35 Diagonal strap
37 Support flange
39 Longitudinal profile
41 Diagonal strut
43 Buffer wall
45 Section
47 Truss support structure
49 Intermediate structural element
51 Support surface
53 Corner area
55 Support surface
57 Longitudinal strip
59 Diagonal strap
61 Mounting plate
63 Vertical web
65 Support element
67 Support

1. A utility vehicle comprising a battery-powered electric drive and a mounting arrangement (11, 23, 47) of battery modules (9) on the chassis (15),
characterized in that
the mounting arrangement has at least one truss support structure (23, 47) with a battery support surface (33, 51), to which at least one battery housing (7) is attached in a force-fit manner, and includes at least one mounting plate (61) that is attached to a frame of the chassis (15) and has a vertical strut (63) to which the truss support structure (23, 47) is attached.

2. Utility vehicle according to claim 1,
characterized in that
the mounting plate (61) is advantageously integrated into a bearing block (13) of a chassis component, such as the stabilizer, the plate cross-member and/or the Panhard rod.

3. Utility vehicle according to claim 1,
characterized in that
the mounting plate (61) is formed by an extension of the bearing block (13) in the longitudinal direction of the chassis frame.

4. Utility vehicle according to claim 1,
characterized in that
the truss support structure (23, 47) is connected to the vertical strut (63) of the mounting plate (61) via a Z-shaped support element (65), which provides the truss support structure (23, 47) with a support (67) and is attached to it, in particular bolted onto it.

5. Utility vehicle according to claim 1,
characterized in that
at least two battery housings (7) are coupled together in a self-supporting manner.

6. Utility vehicle according to claim 1
characterized in that
the battery housings (7) have positive-locking elements (17) and mating positive-locking elements (19) on their front sides facing each other, by means of which the battery housings (7) are positively connected to each other.

7. Utility vehicle according to claim 1,
characterized in that
the positive-locking or mating positive-locking elements in the form of a groove (17) have an undercut which prevents the battery housings (7) from slipping out in the longitudinal direction.

8. Utility vehicle according to claim 1,
characterized in that
the box-like truss support structure (23) is formed by two end structural elements (29) with diagonal straps (31), a base structure (33) with diagonal straps (35) resting on support flanges (37) of the end structural elements (29) and bolted there, longitudinal profiles (39) connect the end structural elements (29) with each other in the respective corner areas, and diagonal struts (41) connect the longitudinal profiles (39) with each other.

9. Utility vehicle according to claim 1,
characterized in that
transverse elastic buffer walls (43) separating the battery housings (7) are arranged within the box-like truss support structure (23).

10. Utility vehicle according to claim 1,
characterized in that
the truss support structure (47) is formed by two structural elements (29, 49) on the end faces and arranged parallel between them with diagonal straps (31) and lower battery support surfaces (51) and support surfaces (55) formed in the upper corner areas (53) that extend lengthways to the structural elements (29) on the end faces.
